(19) United States
(12) Patent Application Publication
(10) Pub. No.: US 2026/0001456 A1
(43) Pub. Date: Jan. 1, 2026

(54) SEATPAD MATERIAL, SEATING SEAT, AND CONVEYANCE SEAT

(71) Applicant: TS TECH CO., LTD., Asaka-shi, Saitama (JP)

(72) Inventor: Yuki TETSUKA, Tochigi (JP)

(21) Appl. No.: 18/992,348

(22) PCT Filed: Jul. 7, 2023
(86) PCT No.: PCT/JP2023/025280

§ 371 Date: Jan. 8, 2025

Related U.S. Application Data
(60) Provisional application No. 63/359,276, filed on Jul. 8, 2022.

(30) Foreign Application Priority Data
Mar. 31, 2023 (JP) 2023-058864
Mar. 31, 2023 (JP) 2023-058865

(51) Int. Cl. B60N 2/56; B60N 2/80

(52) U.S. Cl. CPC B60N 2/5642; B60N 2002/899

(57) ABSTRACT

There is provided a pad material, a seating seat, and a conveyance seat that improve seating comfort while being environmentally friendly, and that do not cause discomfort to a seated occupant. A pad material is used in a seating seat, and supports a seated occupant. The pad material includes a base portion that supports the seated occupant; a side portion disposed outside the base portion in a seat width direction; and a projecting portion that projects from the side portion toward a seated occupant side, and that supports the seated occupant from sides. In the pad material, an entirety of the projecting portion is formed from biomass urethane, and at least a part of the base portion is formed from a material softer than the biomass urethane.

### TECHNICAL FIELD

The present invention relates to a pad material, a seating seat, and a conveyance seat, particularly to a pad material for a seating seat, a seating seat, and a conveyance seat.

### BACKGROUND ART

In recent years, environmentally friendly biomass urethane has been developed. Biomass urethane is a urethane foam containing a raw material including a renewable biomass resource such as plant. Cushion members made of biomass urethane can be applied to various applications such as conveyance seats, cushions, sofas, and door linings.

For example, in a conveyance seat described in PATENT LITERATURE 1, a pad material includes a first cushion member made of biomass urethane, and a second cushion member made of urethane foam. Since the pad material is composed of cushion members having different hardness, deformation of the first cushion member made of biomass urethane can be suppressed by the second cushion member that is less likely to deform than the first cushion member.

### CITATION LIST

### Patent Literature

PATENT LITERATURE 1: JP 2023-001020 A

### SUMMARY OF INVENTION

### Technical Problem

However, since the pad material as disclosed in PATENT LITERATURE 1 is composed of the cushion members having different hardness, a seated occupant may feel discomfort at a boundary portion between the cushion members, which is a risk.

In addition, when the entirety or a part of the pad material is formed from biomass urethane harder than urethane foam, the use of the biomass urethane is environmentally friendly; however, there is a demand for further improvements in seating comfort.

The present invention has been made in view of the above-described problems, and an object of the present invention is to provide a pad material, a seating seat, and a conveyance seat that improve seating comfort while being environmentally friendly, and do not cause discomfort to a seated occupant.

### Solution to Problem

The above-described problems are solved by a pad material of the present invention that is used in a seating seat and that supports a seated occupant, the pad material including: a base portion that supports the seated occupant; a side portion disposed outside the base portion in a seat width direction; and a projecting portion that projects from the side portion toward a seated occupant side, and that supports the seated occupant from sides. In the pad material, an entirety of the projecting portion is formed from biomass urethane, and at least a part of the base portion is formed from a material softer than the biomass urethane.

With the above-described configuration, it is possible to realize the pad material that improves seating comfort while being environmentally friendly, and that does not cause discomfort to the seated occupant.

In detail, the pad material that is environmentally friendly can be realized by using environmentally friendly biomass urethane for the projecting portion, and seating comfort can be improved by using urethane foam, which is softer than the biomass urethane, for a seating surface.

In addition, since the entirety of the projecting portion is formed from the biomass urethane having high hardness, and a boundary portion of a cushion member is not exposed at the projecting portion, seating comfort can be improved without causing discomfort to the seated occupant.

In this case, it is preferable that an entirety of the projecting portion and the side portion of the pad material is formed from the biomass urethane.

With the above-described configuration, the entirety of the projecting portion and the side portion is formed from the biomass urethane having high hardness. For that reason, the rigidity of the projecting portion and the side portion is increased, so that the holding feeling of the pad material can be enhanced while improving seating comfort.

In this case, it is preferable that the side portion is disposed adjacent to the base portion, and it is preferable that a boundary portion between the base portion and the side portion extends from a seating surface of the pad material toward a back surface opposite to the seating surface, and extends perpendicularly to the seating surface of the pad material.

With the above-described configuration, since the projecting portion and the side portion formed from the biomass urethane are not provided on the seating surface, a decline in seating comfort due to the biomass urethane having high hardness can be suppressed.

In this case, it is preferable that the pad material is used in a seat cushion of the seating seat, it is preferable that the base portion supports the seated occupant from below, and it is preferable that the projecting portion has a substantially U-shape when viewed from above, and is formed to surround the base portion.

With the above-described configuration, by providing the projecting portion having high rigidity around the base portion, the holding feeling of the pad material can be enhanced while improving seating comfort.

In this case, it is preferable that the projecting portion of the pad material is formed at both end portions of the base portion in the seat width direction and a rear end portion of the base portion.

With the above-described configuration, by not providing the projecting portion having high rigidity at a position corresponding to the thighs of the seated occupant, a decline in seating comfort due to the biomass urethane having high hardness can be suppressed.

In this case, it is preferable that the seating seat includes the pad material; and a pad material for a headrest that supports a head of the seated occupant, and it is preferable that at least a portion of the pad material for the headrest corresponding to the head of the seated occupant is formed from a material different from the biomass urethane.

With the above-described configuration, damage to the headrest can be suppressed. In detail, the biomass urethane has high hardness, but is brittle and vulnerable to impact. For that reason, when the biomass urethane is used for the headrest, the headrest may be damaged due to impact, which is a risk. Therefore, damage to the headrest can be suppressed by forming the pad material for the headrest from a material other than the biomass urethane.

In this case, it is preferable that the seating seat includes the pad material; and a seat heater provided on the pad material, and it is preferable that the seat heater includes a heater substrate having a sheet shape and provided on the projecting portion of the pad material, a heater wire attached to the heater substrate, and a heat insulator having a heat insulating property and interposed between the projecting portion and the heater substrate.

With the above-described configuration, the heat insulator can make it difficult for heat from the heater wire to be transferred to the biomass urethane. Therefore, deterioration of the biomass urethane due to the influence of heat from the heater wire can be suppressed.

In this case, it is preferable that the seating seat includes a blowing device provided on the pad material, it is preferable that a ventilation passage through which air from the blowing device passes is formed inside the pad material, and it is preferable that a through-hole through which the air from the ventilation passage passes is formed in the heat insulator.

With the above-described configuration, the air from the blowing device is allowed to easily pass through the heat insulator, so that warmth sensation or cool sensation of the seated occupant can be improved.

In this case, it is preferable that a passage hole through which the air from the ventilation passage passes is formed in the heater substrate at a position facing the through-hole of the heat insulator.

With the above-described configuration, the air from the blowing device is allowed to easily pass through the heater substrate, so that warmth sensation or cool sensation of the seated occupant can be further improved.

In addition, the above-described problems are solved by a conveyance seat of the present invention, the conveyance seat including: a pad material for supporting a seated occupant; and a seat frame on which the pad material is disposed. The pad material includes a base portion that supports the seated occupant, a side portion disposed outside the base portion in a seat width direction, and a projecting portion that projects from the side portion toward a seated occupant side, and that supports the seated occupant from sides. In the pad material, an entirety of the projecting portion is formed from biomass urethane, and at least a part of the base portion is formed from a material softer than the biomass urethane.

With the above-described configuration, it is possible to realize the conveyance seat that improves seating comfort while being environmentally friendly, and that does not cause discomfort to the seated occupant.

### Advantageous Effects of Invention

According to the present invention, it is possible to realize the pad material, the seating seat, and the conveyance seat that improve seating comfort while being environmentally friendly, and that do not cause discomfort to the seated occupant.

In addition, according to the present invention, the rigidity of the projecting portion and the side portion is increased, so that the holding feeling of the pad material can be enhanced while improving seating comfort.

In addition, according to the present invention, a decline in seating comfort due to the biomass urethane having high hardness can be suppressed.

In addition, according to the present invention, the holding feeling of the pad material can be enhanced while improving seating comfort.

In addition, according to the present invention, damage to the headrest can be suppressed.

In addition, according to the present invention, deterioration of the biomass urethane due to the influence of heat from the heater wire can be suppressed.

In addition, according to the present invention, warmth sensation or cool sensation of the seated occupant can be improved.

In addition, according to the present invention, warmth sensation or cool sensation of the seated occupant can be further improved.

### BRIEF DESCRIPTION OF DRAWINGS

FIG. 1 is a perspective view of a conveyance seat of the present embodiment.

FIG. 2 is a top view of a pad material.

FIG. 3 is a cross-sectional view taken along line III-III of FIG. 2.

FIG. 4 is a cross-sectional view of a pad material of a first modification example.

FIG. 5 is a cross-sectional view of a pad material of a second modification example.

FIG. 6 is a cross-sectional view of a pad material of a third modification example.

FIG. 7 is a cross-sectional view of a pad material of a fourth modification example.

FIG. 8 is a cross-sectional view of a pad material of a fifth modification example.

FIG. 9 is a top view of a pad material of a sixth modification example.

FIG. 10 is a cross-sectional view taken along line X-X of FIG. 9.

FIG. 11 is a top view of a seat heater.

FIG. 12 is a cross-sectional view taken along line XII-XII of FIG. 11.

FIG. 13 is a perspective view of a conveyance seat of a seventh modification example.

FIG. 14 is a perspective view of a conveyance seat of an eighth modification example.

FIG. 15 is a perspective view of a conveyance seat of a ninth modification example.

FIG. 16 is a perspective view of a conveyance seat of a tenth modification example.

FIG. 17 is a perspective view of a conveyance seat of an eleventh modification example.

### DESCRIPTION OF EMBODIMENTS

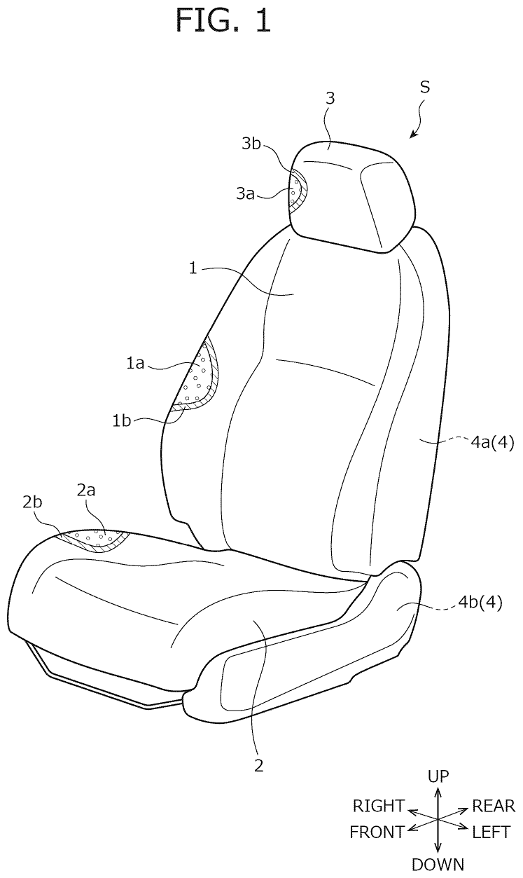

Hereinafter, an embodiment according to the present invention will be described with reference to FIGS. 1 to 3.

As shown in FIG. 1, a seating seat of the present embodiment is, for example, a conveyance seat S installed in a vehicle. Incidentally, the conveyance seat S may be, for example, a seat installed in a ship, an aircraft, or the like. In addition, the seating seat is not limited to the conveyance seat S, and may be a seat such as a general chair, sofa, or cushion.

Incidentally, in the following description, the “front to rear direction” is a front to rear direction of the conveyance seat S, and is a direction coinciding with a traveling direction when the vehicle travels. In addition, the “seat width direction” is a width direction of the conveyance seat S, and is a direction coinciding with a right to left direction when viewed from a seated occupant seated in the conveyance seat S. In addition, the “up to down direction” is an up to down direction of the conveyance seat S, and is a direction coinciding with a vertical direction when the vehicle travels on a horizontal surface.

### Overall Configuration of Seat

As shown in FIG. 1, the conveyance seat S is mainly composed of a seat back 1; a seat cushion 2 connected to a lower portion of the seat back 1; and a headrest 3 connected to an upper portion of the seat back 1.

The seat back 1 is a backrest portion that supports the back of the seated occupant from the rear, and is configured by placing a pad material 1a on a seat frame 4 (back frame 4a) serving as a skeleton, and covering the pad material 1a with a skin material 1b.

The seat cushion 2 is a seating portion that supports the seated occupant from below, and is configured by placing a pad material 2a on the seat frame 4 (cushion frame 4b) serving as a skeleton, and covering the pad material 2a with a skin material 2b.

The headrest 3 is a head portion that supports the head of the seated occupant from the rear, and is configured by placing a pad material 3a on headrest pillars (not illustrated) serving as a core material, and covering the pad material 3a with a skin material 3b.

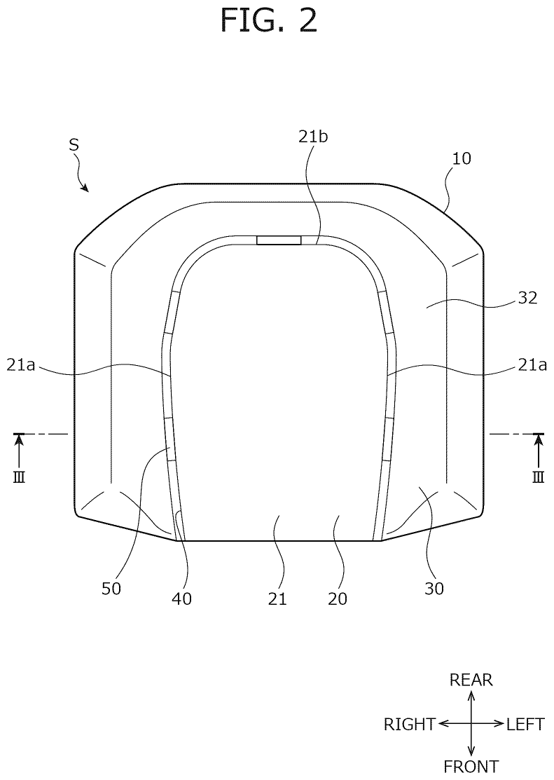

FIG. 2 shows a cushion body portion 10 that is the pad material 2a constituting the seat cushion 2. Incidentally, since the structure of the pad material 1a constituting the seat back 1 is substantially the same as that of the pad material 2a constituting the seat cushion 2, a description thereof will be omitted.

The cushion body portion 10 is the pad material 2a for supporting the seated occupant, and includes a first cushion member 20 serving as a seating portion; a second cushion member 30 provided around the first cushion member 20; a groove portion 40 formed on a front surface 11 of the cushion body portion 10; and an engagement portion 50 provided in the groove portion 40.

The cushion body portion 10 is covered with the skin material 2b by pulling in the skin material 2b using the engagement portion 50 provided in the groove portion 40. The cushion body portion 10 is configured, for example, such that the first cushion member 20, the second cushion member 30, and the engagement portion 50 are integrally formed by insert molding.

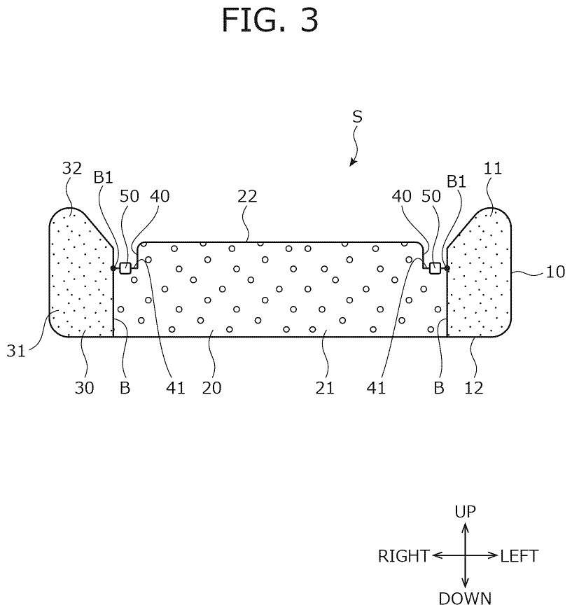

As shown in FIGS. 2 and 3, the first cushion member 20 includes a base portion 21 provided at a central portion of the cushion body portion 10.

The base portion 21 has a seating surface 22 that supports the seated occupant from below. The seating surface 22 is a cushion member having a thickness in the up to down direction, and is formed in a substantially inverted U-shape when viewed from above. Incidentally, the seating surface 22 refers to the front surface 11 on a seated occupant side of the base portion 21 other than the groove portion 40.

As shown in FIGS. 2 and 3, the second cushion member 30 includes a side portion 31 disposed outside the base portion 21 in the seat width direction, and a projecting portion 32 that projects from the side portion 31 toward the seated occupant side (upward), and that supports the seated occupant from the side.

The side portion 31 is a cushion member having substantially the same thickness in the up to down direction as the base portion 21, and is formed in a substantially inverted U-shape when viewed from above.

The projecting portion 32 is a cushion member that is formed integrally with the side portion 31 using the same material, that projects upward from the side portion 31, and that supports the seated occupant from the side.

As shown in FIG. 2, the projecting portion 32 has a substantially U-shape when viewed from above, and is formed to surround the base portion 21. In detail, the projecting portion 32 has a substantially inverted U-shape when viewed from above, is formed at both base end portions 21a on both sides of the base portion 21 in the seat width direction and a rear end portion 21b of the base portion 21, and is disposed to surround the base portion 21 on three sides.

Namely, the projecting portion 32 is not formed at a front end portion of the base portion 21. Therefore, when the seated occupant is seated on the base portion 21, since the projecting portion 32 is not provided at a position corresponding to the thighs of the seated occupant, a decline in seating comfort due to the projecting portion 32 projecting upward can be suppressed.

Here, the first cushion member 20 has a higher hardness than the second cushion member 30. Specifically, the first cushion member 20 is a soft cushion member formed from urethane foam or the like. The second cushion member 30 is a hard cushion member formed from biomass urethane. Namely, the cushion body portion 10 is composed of two types of cushion members formed from different materials and having different hardness.

The first cushion member 20 is, for example, a urethane foam other than biomass urethane (hereinafter, non-biomass urethane), which is molded by foam molding using a urethane foam material. In other words, the non-biomass urethane is a cushion member formed from a material softer than biomass urethane. In order to improve seating comfort, it is preferable that the non-biomass urethane has a high modulus of resilience and low hardness.

The entirety of the base portion 21 is formed from non-biomass urethane. Therefore, seating comfort can be improved by using non-biomass urethane, which is softer than biomass urethane, for the seating surface 22.

The second cushion member 30 is formed from, for example, biomass urethane. Here, the biomass urethane includes hard polyurethane foam with a high biomass ratio.

The entirety of the side portion 31 and the projecting portion 32 is formed from biomass urethane. Therefore, since the side portion 31 and the projecting portion 32 of the second cushion member 30 have a higher hardness and are less flexible than the base portion 21 of the first cushion member 20, deformation of the first cushion member 20 having a lower hardness due to a load from the seated occupant can be suppressed.

Incidentally, the configuration of the cushion body portion 10 may be applied to the pad material 3a constituting the headrest 3. In this case, at least the base portion 21 of the pad material 3a for the headrest 3, the base portion 21 being a portion corresponding to the head of the seated occupant, is formed from a material different from that of the projecting portion 32 of the pad material 3a. Specifically, in the pad material 3a for the headrest 3, the base portion 21 is formed from non-biomass urethane, and the side portion 31 and the projecting portion 32 are formed from biomass urethane.

Therefore, since the base portion 21 of the pad material 3a for the headrest 3 is formed from non-biomass urethane, durability of the base portion 21 can be increased compared to when the base portion 21 is formed from biomass urethane that is brittle and vulnerable to impact. For that reason, damage to the headrest 3 can be suppressed.

The groove portion 40 is a pull-in groove for pulling in the skin material 2b, and is formed on the front surface 11 of the cushion body portion 10. As shown in FIGS. 2 and 3, the groove portion 40 is formed in the vicinity of a boundary portion B between the base portion 21 of the first cushion member 20 and the side portion 31 of the second cushion member 30, and has a substantially inverted U-shape when viewed from above.

Specifically, the groove portion 40 is formed in the base portion 21 of the first cushion member 20 in the vicinity of the boundary portion B on a seating surface 22 side of the cushion body portion 10. In other words, a bottom surface 41 of the groove portion 40 is provided in the first cushion member 20.

Incidentally, in the present embodiment, an example in which the groove portion 40 is a pull-in groove for pulling in the skin material 2b has been described; however, the present invention is not limited thereto. For example, the groove portion 40 may be a groove in which a heating element of a heater provided on the front surface 11 of the cushion body portion 10 is disposed, a groove through which an airbag of an airbag device passes when inflated, or the like.

The engagement portion 50 is a pull-in member for pulling in the skin material 2b, and is, for example, a clip that is formed with a substantially V-shaped cross section. The engagement portion 50 is made of resin, and is formed from, for example, polyacetal (POM) resin, polypropylene (PP) resin, polyamide (PA) resin, polycarbonate (PC) resin, or the like. Incidentally, it is preferable that the engagement portion 50 is formed from polyacetal (POM) resin having relatively high strength.

Incidentally, the engagement portion 50 may be formed with a U-shaped or C-shaped cross section. In addition, the engagement portion 50 is not limited to a clip, and may be a pull-in member such as a metal wire. Further, the engagement portion 50 is not limited to a pull-in member, and may be a pull-in hole for pulling in the skin material 2b.

As shown in FIG. 2, a plurality of the engagement portions 50 are provided inside the groove portion 40 at predetermined spacings. By forming the engagement portions 50 integrally with the cushion body portion 10 during foam molding of the cushion body portion 10, the engagement portions 50 are attached to the cushion body portion 10 in a state where the engagement portions 50 are embedded inside the groove portion 40.

In detail, as shown in FIG. 3, the engagement portions 50 are provided on the first cushion member 20, and are attached such that parts of the engagement portions 50 are embedded in the bottom surface 41 of the groove portion 40.

As shown in FIG. 3, the boundary portion B between the base portion 21 of the first cushion member 20 and the side portion 31 of the second cushion member 30 extends from the seating surface 22, which is provided on the front surface 11 of the cushion body portion 10 (pad material 2a), toward a back surface 12 opposite to the seating surface 22 to be perpendicular to the seating surface 22 of the cushion body portion 10. In other words, a boundary surface between the base portion 21 of the first cushion member 20 and the side portion 31 of the second cushion member 30 is disposed perpendicularly to the seating surface 22 from a boundary end portion B1 provided inside the groove portion 40.

Therefore, since the projecting portion 32 and the side portion 31 of the second cushion member 30 formed from biomass urethane are not provided under the seating surface 22, a decline in seating comfort due to the biomass urethane having high hardness can be suppressed.

In addition, the boundary end portion B1 on the seating surface 22 side of the boundary portion B between the first cushion member 20 and the second cushion member 30 is provided inside the groove portion 40, and is not exposed to the seating surface 22.

In detail, the boundary end portion B1 that is an upper end portion of the boundary surface between the base portion 21 of the first cushion member 20 and the side portion 31 of the second cushion member 30 is provided on the bottom surface 41 of the groove portion 40. Therefore, neither an end portion on the seated occupant side nor an end portion on a back surface 12 side opposite to the seated occupant side of the boundary portion B between the first cushion member 20 and the second cushion member 30 is provided on the seating surface 22.

In such a manner, even when the cushion body portion 10 is composed of the first cushion member 20 and the second cushion member 30 having different hardness, seating comfort can be improved at the boundary portion B between the first cushion member 20 and the second cushion member 30 without causing discomfort to the seated occupant.

In addition, since the engagement portions 50 are provided on the side of the first cushion member 20 made of non-biomass urethane softer than the second cushion member 30 made of biomass urethane, when a load from the seated occupant is applied to the cushion body portion 10, the engagement portions 50 are likely to sink, so that seating comfort can be further improved without causing discomfort to the seated occupant.

Further, since the entirety of the projecting portion 32 is formed from biomass urethane, and the boundary portion B between the first cushion member 20 and the second cushion member 30 is not exposed at the projecting portion 32, seating comfort can be further improved.

### First Modification Example

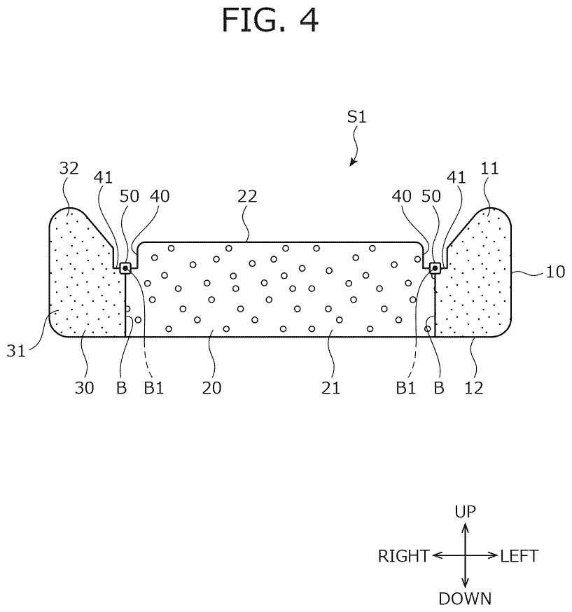

Next, a first modification example of the conveyance seat S will be described with reference to FIG. 4. Incidentally, the description of contents that overlap with those of the conveyance seat S described above will be omitted.

In a conveyance seat S1 of the first modification example, the groove portion 40 is formed in the base portion 21 of the first cushion member 20 in the vicinity of the boundary portion B on the seating surface 22 side of the cushion body portion 10. In other words, the bottom surface 41 of the groove portion 40 is provided in the first cushion member 20 and the second cushion member 30.

As shown in FIG. 4, the engagement portion 50 is attached to straddle the boundary portion B between the first cushion member 20 and the second cushion member 30, and to be partially embedded in the bottom surface 41 of the groove portion 40.

In such a manner, even in the conveyance seat S1 of the first modification example, the boundary end portion B1 on the seating surface 22 side of the boundary portion B between the first cushion member 20 and the second cushion member 30 is provided inside the groove portion 40, and is not exposed to the seating surface 22. Therefore, seating comfort can be improved at the boundary portion B between the first cushion member 20 and the second cushion member 30 without causing discomfort to the seated occupant.

In addition, since the engagement portion 50 is attached to the bottom surface 41 of the groove portion 40 to straddle the boundary portion B between the first cushion member 20 and the second cushion member 30, the bonding strength between the first cushion member 20 and the second cushion member 30 made of different materials and having different hardness can be increased.

### Second Modification Example

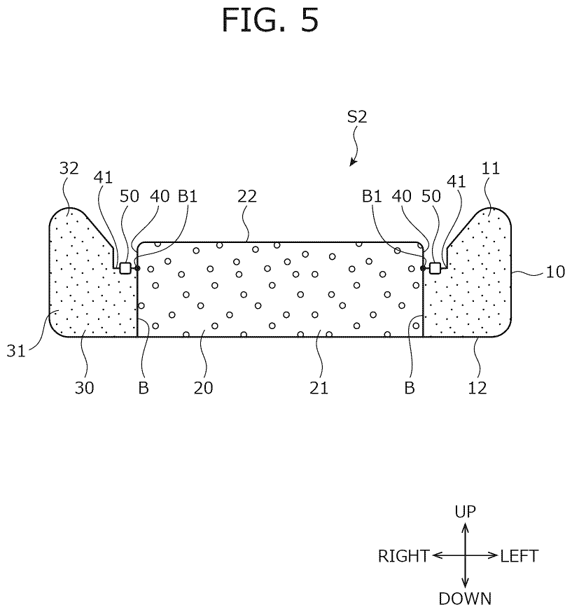

Next, a second modification example of the conveyance seat S will be described with reference to FIG. 5. Incidentally, the description of contents that overlap with those of the conveyance seats S and S1 described above will be omitted.

In a conveyance seat S2 of the second modification example, the groove portion 40 is formed in the side portion 31 of the second cushion member 30 in the vicinity of the boundary portion B on the seating surface 22 side of the cushion body portion 10. In other words, the bottom surface 41 of the groove portion 40 is provided in the second cushion member 30.

As shown in FIG. 5, the engagement portion 50 is provided on the second cushion member 30, and is attached such that a part of the engagement portion 50 is embedded in the bottom surface 41 of the groove portion 40.

In such a manner, even in the conveyance seat S2 of the second modification example, the boundary end portion B1 on the seating surface 22 side of the boundary portion B between the first cushion member 20 and the second cushion member 30 is provided inside the groove portion 40, and is not exposed to the seating surface 22. Therefore, seating comfort can be improved at the boundary portion B between the first cushion member 20 and the second cushion member 30 without causing discomfort to the seated occupant.

In addition, since the engagement portion 50 is provided on the side of the second cushion member 30 made of biomass urethane harder than the first cushion member 20 made of non-biomass urethane, the attachment strength of the engagement portion 50 to the cushion body portion 10 can be increased. Therefore, the attachment strength of the skin material 2b to the pad material 2a can be increased.

### Third Modification Example

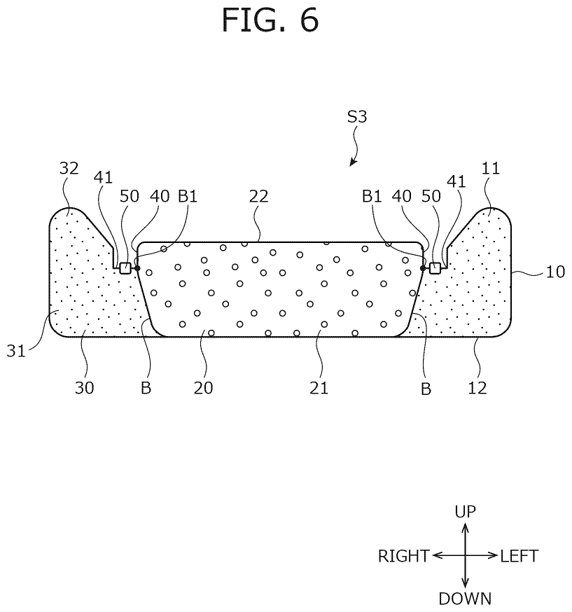

Next, a third modification example of the conveyance seat S will be described with reference to FIG. 6. Incidentally, the description of contents that overlap with those of the conveyance seats S, S1, and S2 described above will be omitted.

In a conveyance seat S3 of the third modification example, the boundary portion B between the base portion 21 of the first cushion member 20 and the side portion 31 of the second cushion member 30 extends from the seating surface 22, which is provided on the front surface 11 of the cushion body portion 10, toward the back surface 12 opposite to the seating surface 22 such that the side portion 31 enters below the seating surface 22. In other words, the boundary surface between the base portion 21 of the first cushion member 20 and the side portion 31 of the second cushion member 30 is disposed to incline inward in the seat width direction with respect to the seating surface 22 from the boundary end portion B1 provided inside the groove portion 40.

Therefore, since the side portion 31 of the second cushion member 30 formed from biomass urethane enters below the base portion 21, deformation of the first cushion member 20 due to a load from the seated occupant, the first cushion member 20 being formed from non-biomass urethane having low hardness, can be suppressed.

### Fourth Modification Example

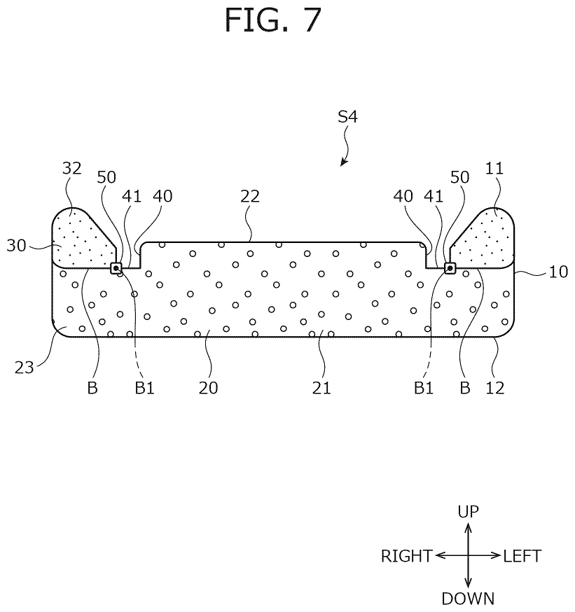

Next, a fourth modification example of the conveyance seat S will be described with reference to FIG. 7. Incidentally, the description of contents that overlap with those of the conveyance seats S and S1 to S3 described above will be omitted.

In a conveyance seat S4 of the fourth modification example, the first cushion member 20 includes the base portion 21 provided at the central portion of the cushion body portion 10, and a second side portion 23 disposed outside the base portion 21 in the seat width direction. Namely, in the cushion body portion 10, the base portion 21 and the second side portion 23 are formed from non-biomass urethane, and the projecting portion 32 is formed from biomass urethane.

The groove portion 40 is formed in the second side portion 23 of the first cushion member 20 in the vicinity of the boundary portion B on the seating surface 22 side of the cushion body portion 10. The engagement portion 50 is attached to straddle the boundary portion B between the first cushion member 20 and the second cushion member 30, and to be partially embedded in the bottom surface 41 of the groove portion 40.

As shown in FIG. 7, the boundary portion B between the second side portion 23 of the first cushion member 20 and the projecting portion 32 of the second cushion member 30 extends horizontally from the groove portion 40, which is provided on the front surface 11 of the cushion body portion 10, toward the outside in the seat width direction. In other words, a boundary surface between the second side portion 23 of the first cushion member 20 and the projecting portion 32 of the second cushion member 30 is disposed to be parallel to the seating surface 22 from the boundary end portion B1 provided inside the groove portion 40.

Therefore, the volume of the projecting portion 32 of the second cushion member 30 formed from biomass urethane can be reduced, and seating comfort can be improved.

### Fifth Modification Example

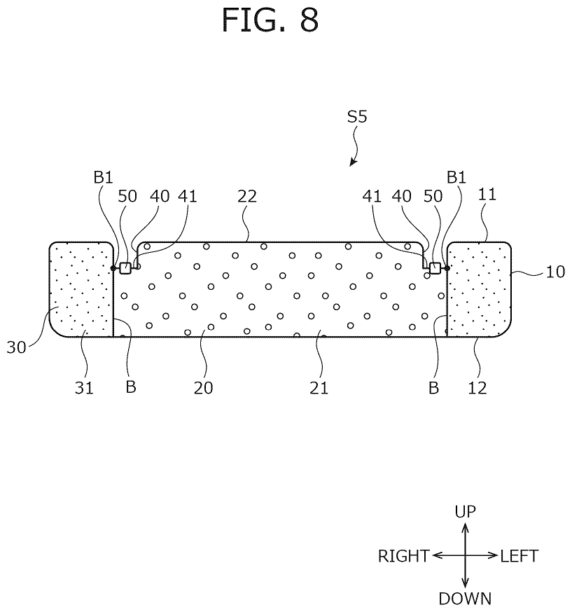

Next, a fifth modification example of the conveyance seat S will be described with reference to FIG. 8. Incidentally, the description of contents that overlap with those of the conveyance seats S and S1 to S4 described above will be omitted.

In a conveyance seat S5 of the fifth modification example, the second cushion member 30 includes only the side portion 31 disposed outside the base portion 21 in the seat width direction, and is not provided with the projecting portion 32.

In such a manner, even in the conveyance seat S5 of the fifth modification example, the boundary end portion B1 on the seating surface 22 side of the boundary portion B between the first cushion member 20 and the second cushion member 30 is provided inside the groove portion 40, and is not exposed to the seating surface 22. Therefore, seating comfort can be improved at the boundary portion B between the first cushion member 20 and the second cushion member 30 without causing discomfort to the seated occupant.

### Sixth Modification Example

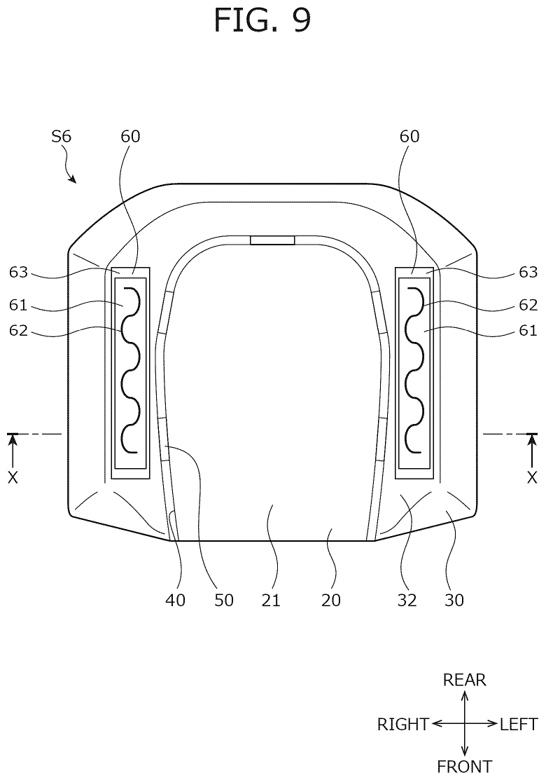

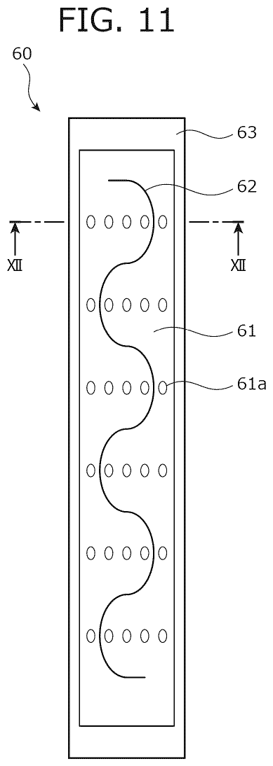

Next, a sixth modification example of the conveyance seat S will be described with reference to FIGS. 9 to 12. Incidentally, the description of contents that overlap with those of the conveyance seats S and S1 to S5 described above will be omitted.

A conveyance seat S6 of the sixth modification example includes the pad material 2a (cushion body portion 10) of the seat cushion 2; the skin material 2b covering the pad material 2a; a seat heater 60 having a sheet shape and provided between the pad material 2a and the skin material 2b; and a blowing device 70 provided under the pad material 2a. Incidentally, the seat heater 60 and the blowing device 70 may be provided in the seat back 1 or the headrest 3.

A ventilation passage 13 through which air from the blowing device 70 passes is formed inside the cushion body portion 10. The ventilation passage 13 includes a first ventilation passage 24 provided in the first cushion member 20 and connected to a blowing passage 71 of the blowing device 70 to be described later, and a second ventilation passage 33 that is provided in the second cushion member 30 and that blows air to the projecting portion 32.

The seat heater 60 is a planar heating element that warms the seat cushion 2, is attached inside the skin material 2b of the seat cushion 2, and is provided on the pad material 2a (cushion body portion 10). Incidentally, the seat heater 60 is connected to a power supply and a control device via a harness (not illustrated).

As shown in FIGS. 9 to 12, the seat heater 60 includes a heater substrate 61 having a sheet shape; a heater wire 62 attached to the heater substrate 61; and a heat insulator 63 having a heat insulating property and interposed between the projecting portion 32 and the heater substrate 61.

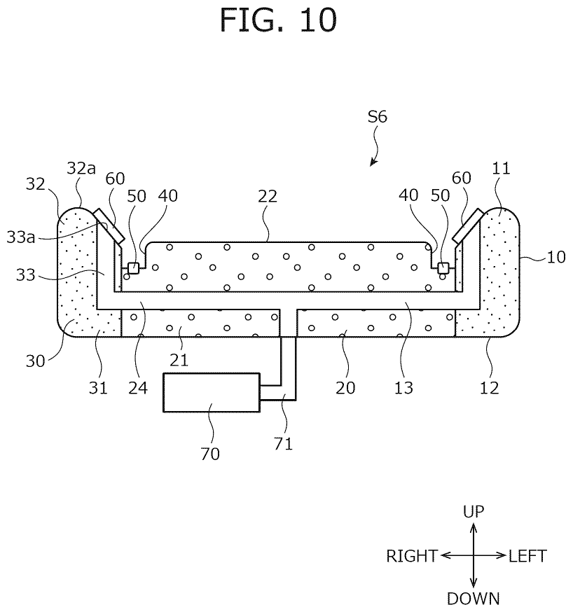

The heater substrate 61 is made of a stretchable fabric material, and serves as the base portion of the seat heater 60. As shown in FIGS. 9 and 10, the heater substrate 61 is provided on an attachment surface 32a of the projecting portion 32 of the cushion body portion 10. The attachment surface 32a is a surface of the projecting portion 32 that is inclined toward the seated occupant side (inward in the seat width direction).

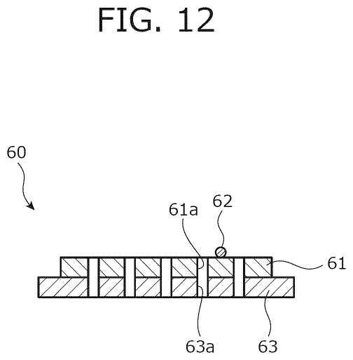

As shown in FIG. 12, passage holes 61a penetrating through the heater substrate 61 in a thickness direction are formed in the heater substrate 61. The passage holes 61a are formed at positions facing through-holes 63a of the heat insulator 63 to be described later.

As shown in FIGS. 9, 11, and 12, the heater wire 62 is fixed onto the heater substrate 61 by adhesion. Incidentally, the heater wire 62 may be attached onto the heater substrate 61 by sewing or the like.

The heater wire 62 extends in a meandering manner from a rear end portion of the heater substrate 61 toward the front side.

The heat insulator 63 is, for example, a member made of glass wool, rock wool, or the like and having low thermal conductivity, and makes it difficult for heat from the heater wire 62 to be transferred to the projecting portion 32 of the cushion body portion 10. As shown in FIGS. 9 and 10, the heat insulator 63 is attached to the attachment surface 32a of the projecting portion 32 of the cushion body portion 10.

As shown in FIG. 12, the through-holes 63a through which air from the blowing passage 71 to be described later passes are formed in the heat insulator 63. The through-holes 63a penetrate through the heat insulator 63 in the thickness direction, and are formed at positions facing the passage holes 61a of the heater substrate 61.

In such a manner, by providing the heat insulator 63 between the projecting portion 32 of the second cushion member 30 and the heater substrate 61, deterioration of the second cushion member 30, which is formed from biomass urethane, due to the influence of heat from the heater wire 62 can be suppressed.

The blowing device 70 is a blower device that sends air to the seated occupant seated on the seat cushion 2, and is provided below the seat cushion 2. Incidentally, the seat heater 60 is connected to the power supply and the control device via a harness (not illustrated).

As shown in FIG. 10, the blowing device 70 has the blowing passage 71 connected to the first ventilation passage 24 of the cushion body portion 10. The air sent from the blowing device 70 passes through the first ventilation passage 24 and the second ventilation passage 33 via the blowing passage 71, and is sent toward the seated occupant from an outlet 33a formed in the projecting portion 32.

As shown in FIGS. 10 and 12, the air sent from the blowing device 70 is sent from the outlet 33a formed in the projecting portion 32 toward the seated occupant through the passage holes 61a and the through-holes 63a of the seat heater 60.

In such a manner, by providing the passage holes 61a and the through-holes 63a in the heater substrate 61 and the heat insulator 63, respectively, the air from the blowing device 70 is allowed to easily pass through the heater substrate 61 and the heat insulator 63, so that warmth sensation or cool sensation of the seated occupant can be improved.

### Seventh Modification Example

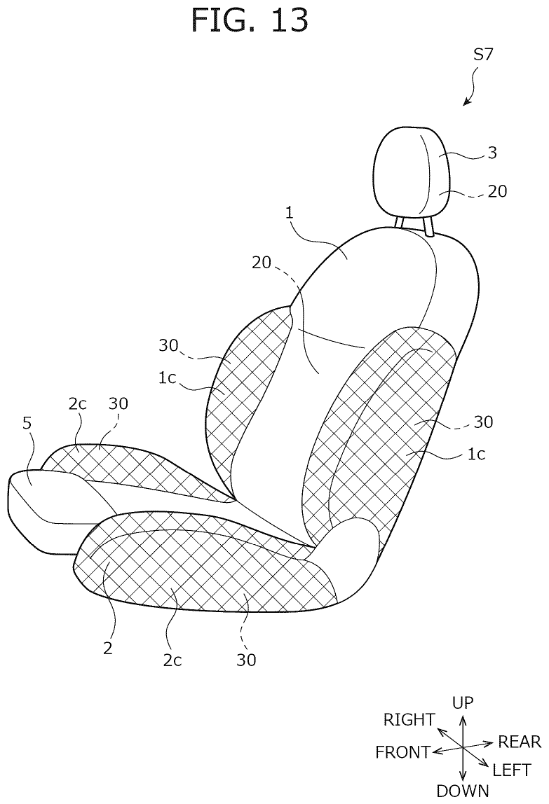

Next, a seventh modification example of the conveyance seat S will be described with reference to FIG. 13. Incidentally, the description of contents that overlap with those of the conveyance seats S and S1 to S6 described above will be omitted.

As shown in FIG. 13, a conveyance seat S7 of the seventh modification example is mainly composed of the seat back 1; the seat cushion 2 connected to the lower portion of the seat back 1; the headrest 3 connected to the upper portion of the seat back 1; and a footrest 5 connected to a front portion of the seat cushion 2. The footrest 5 is a member that supports the legs of the seated occupant from below.

In the seat back 1, the cushion body portion 10 corresponding to a back bulging portion 1c that is a side portion of the seat back 1 uses the second cushion member 30 made of biomass urethane.

In addition, in the seat cushion 2, the cushion body portion 10 corresponding to a bulging portion 2c that is a side portion of the seat cushion 2 uses the second cushion member 30 made of biomass urethane.

Incidentally, the cushion body portions 10 corresponding to portions of the seat back 1 other than the back bulging portion 1c, portions of the seat cushion 2 other than the bulging portion 2c, the headrest 3, and the footrest 5 are formed from non-biomass urethane.

In such a manner, since the second cushion member 30 formed from biomass urethane is disposed to avoid the seating portion of the seated occupant, seating comfort of the conveyance seat S7 can be improved.

### Eighth Modification Example

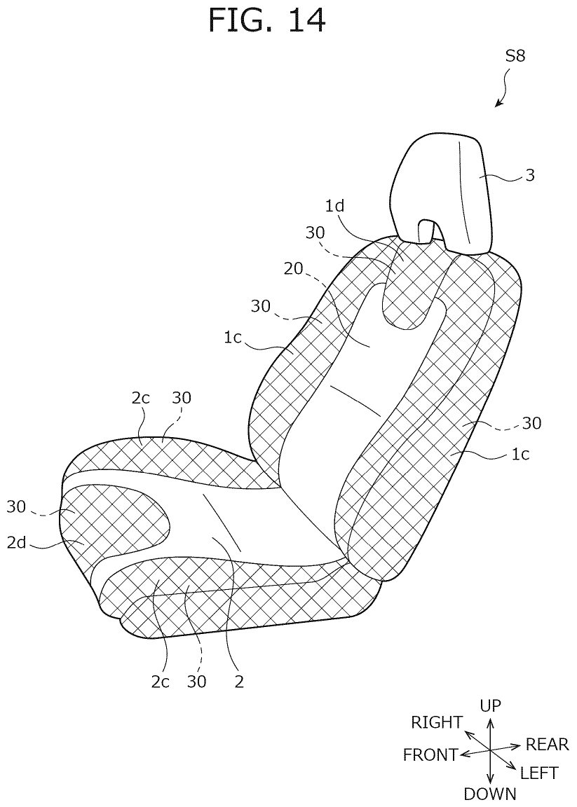

Next, an eighth modification example of the conveyance seat S will be described with reference to FIG. 14. Incidentally, the description of contents that overlap with those of the conveyance seats S and SI to S7 described above will be omitted.

As shown in FIG. 14, a conveyance seat S8 of the eighth modification example is mainly composed of the seat back 1; the seat cushion 2 connected to the lower portion of the seat back 1; and the headrest 3 connected to the upper portion of the seat back 1.

In the seat back 1, the cushion body portion 10 corresponding to the back bulging portion 1c that is a side portion of the seat back 1 uses the second cushion member 30 made of biomass urethane.

In addition, in the seat back 1, the cushion body portion 10 corresponding to a backrest upper portion 1d that is an upper central portion of the seat back 1 uses the second cushion member 30 made of biomass urethane.

In the seat cushion 2, the cushion body portion 10 corresponding to the bulging portion 2c that is a side portion of the seat cushion 2 uses the second cushion member 30 made of biomass urethane.

In addition, in the seat cushion 2, the cushion body portion 10 corresponding to a seat front end portion 2d that is a front central portion of the seat cushion 2 uses the second cushion member 30 made of biomass urethane.

Incidentally, the cushion body portions 10 corresponding to portions of the seat back 1 other than the back bulging portion 1c and the backrest upper portion 1d, portions of the seat cushion 2 other than the bulging portion 2c and the seat front end portion 2d, and the headrest 3 are formed from non-biomass urethane.

In such a manner, since the second cushion member 30 formed from biomass urethane is disposed to avoid the seating portion of the seated occupant, seating comfort of the conveyance seat S8 can be improved.

### Ninth Modification Example

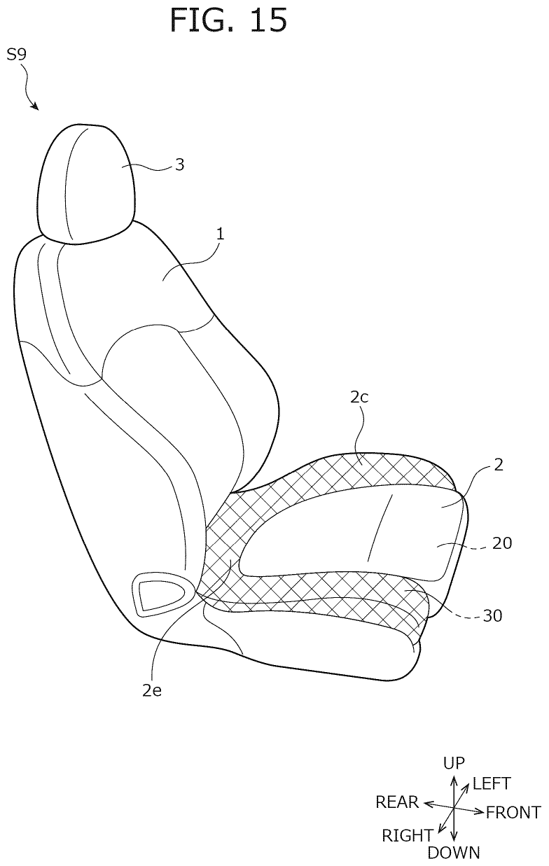

Next, a ninth modification example of the conveyance seat S will be described with reference to FIG. 15. Incidentally, the description of contents that overlap with those of the conveyance seats S and SI to S8 described above will be omitted.

As shown in FIG. 15, a conveyance seat S9 of the ninth modification example is mainly composed of the seat back 1; the seat cushion 2 connected to the lower portion of the seat back 1; and the headrest 3 connected to the upper portion of the seat back 1.

In the seat cushion 2, the cushion body portion 10 corresponding to the bulging portion 2c that is a side portion of the seat cushion 2 uses the second cushion member 30 made of biomass urethane.

In addition, in the seat cushion 2, the cushion body portion 10 corresponding to a seat rear end portion 2e that is a rear central portion of the seat cushion 2 uses the second cushion member 30 made of biomass urethane.

Incidentally, the cushion body portions 10 corresponding to portions of the seat back 1 and the seat cushion 2 other than the bulging portion 2c and the seat rear end portion 2e, and the headrest 3 are formed from non-biomass urethane.

In such a manner, since the second cushion member 30 formed from biomass urethane is disposed to avoid the seating portion of the seated occupant, seating comfort of the conveyance seat S9 can be improved.

### Tenth Modification Example

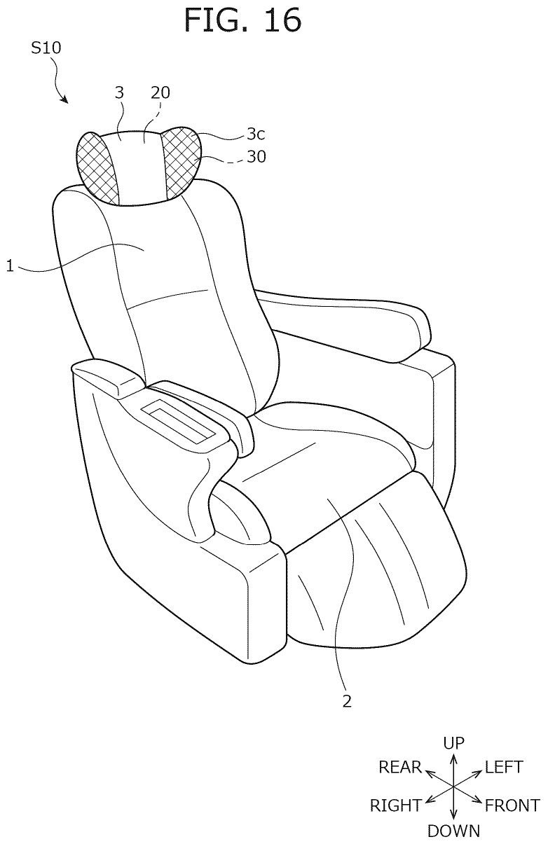

Next, a tenth modification example of the conveyance seat S will be described with reference to FIG. 16. Incidentally, the description of contents that overlap with those of the conveyance seats S and S1 to S9 described above will be omitted.

As shown in FIG. 16, a conveyance seat S10 of the tenth modification example is mainly composed of the seat back 1; the seat cushion 2 connected to the lower portion of the seat back 1; and the headrest 3 connected to the upper portion of the seat back 1.

In the headrest 3, the cushion body portion 10 corresponding to a side portion 3c that is a side portion of the headrest 3 uses the second cushion member 30 made of biomass urethane.

Incidentally, the cushion body portions 10 corresponding to the seat back 1, the seat cushion 2, and portions of the headrest 3 other than the side portion 3c are formed from non-biomass urethane.

In such a manner, since the second cushion member 30 formed from biomass urethane is disposed to avoid the seating portion of the seated occupant, seating comfort of the conveyance seat S10 can be improved.

### Eleventh Modification Example

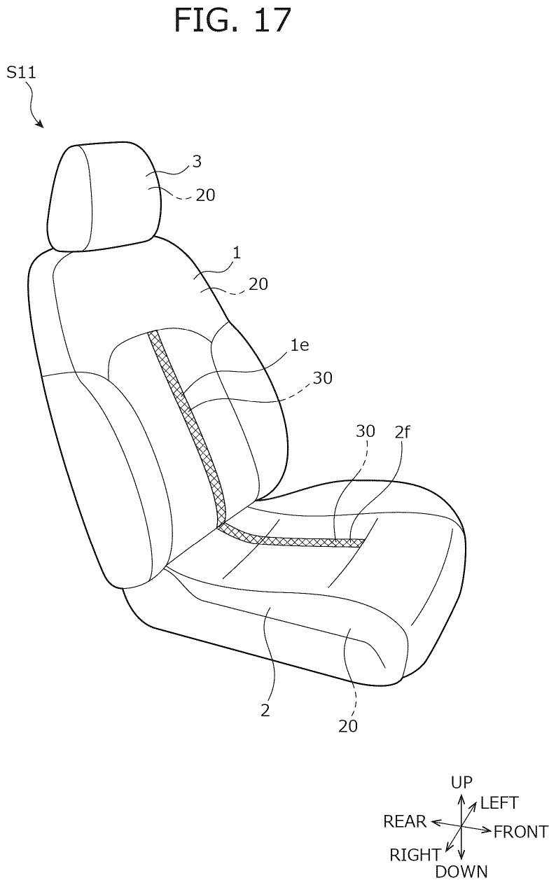

Next, an eleventh modification example of the conveyance seat S will be described with reference to FIG. 17. Incidentally, the description of contents that overlap with those of the conveyance seats S and S1 to S10 described above will be omitted.

As shown in FIG. 17, a conveyance seat S11 of the eleventh modification example is mainly composed of the seat back 1; the seat cushion 2 connected to the lower portion of the seat back 1; and the headrest 3 connected to the upper portion of the seat back 1.

In the seat back 1, the cushion body portion 10 corresponding to a back decorative portion le that is a central portion of the seat back 1 and that is decorated uses the second cushion member 30 made of biomass urethane.

In the seat cushion 2, the cushion body portion 10 corresponding to a cushion decorative portion 2f that is a central portion of the seat cushion 2 and that is decorated uses the second cushion member 30 made of biomass urethane.

Incidentally, the portions cushion body 10 corresponding to portions of the seat back 1 other than the back decorative portion le, portions of the seat cushion 2 other than the cushion decorative portion 2f, and the headrest 3 are formed from non-biomass urethane.

In such a manner, since the second cushion member 30 formed from biomass urethane is disposed to avoid the seating portion of the seated occupant, seating comfort of the conveyance seat S10 can be improved.

### Supplementary Notes

A pad material of the present invention is a pad material that is used in a seating seat, and that supports a seated occupant, the pad material including: a first cushion member; and a second cushion member provided adjacent to the first cushion member and having a higher hardness than the first cushion member. A groove portion recessed toward a back surface of the pad material is formed on a seating surface provided on a front surface of the pad material. An end portion of a boundary portion between the first cushion member and the second cushion member is provided in the groove portion, the end portion being located on a seating surface side, and is provided not to be exposed to the seating surface.

With the above-described configuration, it is possible to realize the pad material that improves seating comfort while being environmentally friendly, and that does not cause discomfort to the seated occupant.

In detail, the pad material that is environmentally friendly can be realized by using environmentally friendly biomass urethane for a projecting portion, and seating comfort can be improved by using urethane foam, which is softer than the biomass urethane, for the seating surface.

In addition, since the boundary portion between the cushion members is not exposed to the seating surface, seating comfort can be improved without causing discomfort to the seated occupant.

In this case, it is preferable that the seating seat includes the pad material, a skin material covering the pad material, and an engagement portion that is provided in the pad material and that pulls the skin material into the pad material, and it is preferable that the engagement portion is attached to a bottom surface of the groove portion of the pad material.

With the above-described configuration, since a recess of a pull-in groove is used and the boundary portion between the cushion members is not exposed to the seating surface, seating comfort can be improved with a simple configuration without causing discomfort to the seated occupant.

In this case, it is preferable that the second cushion member is formed from biomass urethane, it is preferable that the bottom surface of the groove portion is provided in the first cushion member, and it is preferable that the engagement portion is provided on the first cushion member and on the bottom surface of the groove portion.

With the above-described configuration, since the engagement portion is provided on the side of the first cushion member made of non-biomass urethane softer than the second cushion member made of biomass urethane, when a load from the seated occupant is applied to the pad material, the engagement portion is likely to sink, so that seating comfort can be further improved without causing discomfort to the seated occupant.

In this case, it is preferable that the second cushion member is formed from biomass urethane, it is preferable that the bottom surface of the groove portion is provided in the first cushion member and the second cushion member, and it is preferable that the engagement portion is provided on the bottom surface of the groove portion to straddle the boundary portion between the first cushion member and the second cushion member.

With the above-described configuration, since the engagement portion is attached to the bottom surface of the groove portion to straddle the first cushion member and the second cushion member, the bonding strength between the first cushion member and the second cushion member made of different materials and having different hardness can be increased.

In this case, it is preferable that the second cushion member is formed from biomass urethane, it is preferable that the bottom surface of the groove portion is provided in the second cushion member, and it is preferable that the engagement portion is provided on the second cushion member and on the bottom surface of the groove portion. With the above-described configuration, since the engagement portion is provided on the side of the second cushion member made of biomass urethane harder than the first cushion member made of non-biomass urethane, the attachment strength of the engagement portion to the pad material can be increased.

In addition, a conveyance seat of the present invention is a conveyance seat, including: a pad material for supporting a seated occupant; and a seat frame on which the pad material is disposed. The pad material includes a first cushion member and a second cushion member having a higher hardness than the first cushion member. A groove portion is formed on a seating surface of the pad material. An end portion on a seating surface side of a boundary portion between the first cushion member and the second cushion member is provided in the groove portion, and is not exposed to the seating surface.

With the above-described configuration, it is possible to realize the conveyance seat that improves seating comfort while being environmentally friendly, and that does not cause discomfort to the seated occupant.

In the above-described embodiment, the vehicle seat used in automobiles has been described as a specific example; however, the present invention is not particularly limited, and can be used for various seats such as office chairs for work, wheelchairs, and child chairs for shopping carts in addition to two-wheeled seats for two-wheeled vehicles, vehicle seats for trains, buses or the like, and conveyance seats for airplanes, ships, or the like.

In the present embodiment, the vehicle seat according to the present invention has been mainly described.

However, the above-described embodiment is merely one example for easy understanding of the present invention, and does not limit the present invention. The present invention can be modified and improved without departing from the concept of the present invention, and it goes without saying that the present invention includes its equivalents.

### REFERENCE SIGNS LIST

S, S1 to S11: conveyance seat (seating seat)
1: seat back
   1a: pad material
   1b: skin material
   1c: back bulging portion
   1d: backrest upper portion
   1e: back decorative portion
2: seat cushion
   2a: pad material
   2b: skin material
   2c: bulging portion
   2d: seat front end portion
   2e: seat rear end portion
   2f: cushion decorative portion
3: headrest
   3a: pad material (pad material for headrest)
   3b: skin material
   3c: side portion
4: seat frame
5: footrest
10: cushion body portion
11: front surface
12: back surface
13: ventilation passage
20: first cushion member
21: base portion
   21a: base end portion (both end portions)
   21b: rear end portion
22: seating surface
23: second side portion
24: first ventilation passage
30: second cushion member
31: side portion
32: projecting portion
   32a: attachment surface
33: second ventilation passage
   33a: outlet
40: groove portion
41: bottom surface
50: engagement portion
60: seat heater
61: heater substrate
   61a: passage hole
62: heater wire
63: heat insulator
   63a: through-hole
70: blowing device
71: blowing passage
B: boundary portion
B1: boundary end portion (end portion on seating surface side)

1. A pad material that is used in a seating seat, and that supports a seated occupant, comprising:
a base portion that supports the seated occupant;
a side portion disposed outside the base portion in a seat width direction; and
a projecting portion that projects from the side portion toward a seated occupant side, and that supports the seated occupant from sides,
wherein in the pad material, an entirety of the projecting portion is formed from biomass urethane, and at least a part of the base portion is formed from a material softer than the biomass urethane.

2. The pad material according to claim 1,
wherein an entirety of the projecting portion and the side portion of the pad material is formed from the biomass urethane.

3. The pad material according to claim 2,
wherein the side portion is disposed adjacent to the base portion, and
a boundary portion between the base portion and the side portion extends from a seating surface of the pad material toward a back surface opposite to the seating surface, and extends perpendicularly to the seating surface of the pad material.

4. The pad material according to claim 1,
wherein the pad material is used in a seat cushion of the seating seat,
the base portion supports the seated occupant from below, and
the projecting portion has a substantially U-shape when viewed from above, and is formed to surround the base portion.

5. The pad material according to claim 4,
wherein the projecting portion of the pad material is formed at both end portions of the base portion in the seat width direction and a rear end portion of the base portion.

6. A seating seat, comprising:
the pad material according to claim 1; and
a pad material for a headrest that supports a head of the seated occupant,
wherein at least a portion of the pad material for the headrest corresponding to the head of the seated occupant is formed from a material different from the biomass urethane.

7. A seating seat, comprising:
the pad material according to claim 1; and
a seat heater provided on the pad material,
wherein the seat heater includes a heater substrate having a sheet shape and provided on the projecting portion of the pad material, a heater wire attached to the heater substrate, and a heat insulator having a heat insulating property and interposed between the projecting portion and the heater substrate.

8. The seating seat according to claim 7,
wherein the seating seat includes a blowing device provided on the pad material,
a ventilation passage through which air from the blowing device passes is formed inside the pad material, and
a through-hole through which the air from the ventilation passage passes is formed in the heat insulator.

9. The seating seat according to claim 8,
wherein a passage hole through which the air from the ventilation passage passes is formed in the heater substrate at a position facing the through-hole of the heat insulator.

10. A conveyance seat, comprising:
a pad material for supporting a seated occupant; and
a seat frame on which the pad material is disposed,
wherein the pad material includes a base portion that supports the seated occupant, a side portion disposed outside the base portion in a seat width direction, and a projecting portion that projects from the side portion toward a seated occupant side, and that supports the seated occupant from sides, and
in the pad material, an entirety of the projecting portion is formed from biomass urethane, and at least a part of the base portion is formed from a material softer than the biomass urethane.
